(19) United States
(12) Patent Application Publication
(10) Pub. No.: US 2024/0225340 A1
(43) Pub. Date: Jul. 11, 2024

(54) METHOD FOR COOKING, STORAGE MEDIUM, COOKING DEVICE, AND COOKING APPLIANCE

(71) Applicant: FOSHAN SHUNDE MIDEA ELECTRICAL HEATING APPLIANCES MANUFACTURING CO., LTD., Foshan (CN)

(72) Inventors: Jixuan LIANG, Foshan (CN); Qingsong GU, Foshan (CN)

(21) Appl. No.: 18/405,596

(22) Filed: Jan. 5, 2024

(30) Foreign Application Priority Data
Jan. 6, 2023 (CN) 202310019628.5

(51) Int. Cl. A47J 27/08; A23L 5/10; A23L 11/00

(52) U.S. Cl. CPC A47J 27/0802; A23L 5/13; A23L 5/17; A23L 11/01

(57) ABSTRACT

A method for cooking includes controlling a cooking appliance to enter a temperature-rising and skin-breaking stage in response to a cooking start instruction, controlling the cooking appliance to enter a heat preservation and water absorption stage after the temperature-rising and skin-breaking stage, and controlling the cooking appliance to enter a pressure cooking stage in response to a duration of heat preservation and water absorption reaches a preset duration, until cooking is finished.

### CROSS-REFERENCE TO RELATED APPLICATION

This application claims priority to Chinese Application No. 202310019628.5, filed on Jan. 6, 2023, the entire content of which is incorporated herein by reference.

### TECHNICAL FIELD

The disclosure relates to the technical field of cooking, and in particular to a method for cooking, a storage medium, a cooking device, and a cooking appliance.

### BACKGROUND

Some kinds of beans need to be soaked for a long time to absorb water, and then need to be boiled in water for a long time to complete cooking thereof. Taking white kidney beans as an example, the white kidney beans may need to be soaked for an entire night to absorb water. If it is summer, improper soaking may cause the white kidney beans to be sour, and the white kidney beans need to be soaked in a refrigerated environment of a refrigerator. In the related art, it takes a long cooking duration for beans to be cooked thoroughly.

### SUMMARY

In view of this, it is desired for embodiments of the disclosure to provide a method for cooking beans, a storage medium, a cooking device, and a cooking appliance, to shorten a cooking duration required for the beans to be cooked thoroughly.

In order to achieve the above purpose, according to a first aspect of the embodiments of the disclosure, there is provided a method for cooking beans, the method includes the following operations.

A temperature-rising and skin-breaking stage is entered in response to a bean cooking start instruction.

A heat preservation and water absorption stage is entered after the temperature-rising and skin-breaking stage.

A pressure cooking stage is entered when a duration of heat preservation and water absorption reaches a first preset duration, until cooking is finished.

In an embodiment, the method may further include the following operations.

A cooling-down stage is entered when a cooking chamber is heated to any one of first preset conditions in the temperature-rising and skin-breaking stage.

The first preset conditions include that:
temperature of the cooking chamber is equal to or greater than a first temperature which is a highest temperature corresponding to opening of skins of the beans; and
a heating duration of the cooking chamber is equal to or greater than a second preset duration.

In an embodiment, the second preset duration may be a duration required for the cooking chamber to be heated to the first temperature in a case that the cooking chamber is fully loaded.

In an embodiment, the beans may be white kidney beans, the first temperature is 95° C. to 105° C., and the second preset duration is 30 minutes to 60 minutes.

In an embodiment, the operation of entering the heat preservation and water absorption stage after the temperature-rising and skin-breaking stage may include the following operations.

The heat preservation and water absorption stage is entered when the cooking chamber is cooled to any one of second preset conditions in the cooling-down stage.

The second preset conditions include that:
the temperature of the cooking chamber is less than or equal to a second temperature which belongs to a temperature set corresponding to the cooking chamber in the heat preservation and water absorption stage; and
a cooling duration of the cooking chamber is equal to or greater than a third preset duration.

In an embodiment, the third preset duration may be a duration required for the cooking chamber to drop from the first temperature to the second temperature in a case that the cooking chamber is fully loaded.

In an embodiment, a low temperature boundary of the temperature set may be a third temperature, a high temperature boundary of the temperature set is a fourth temperature, the second temperature is equal to or greater than the third temperature and is less than or equal to the fourth temperature.

The method may further include the following operations.

Heating of the cooking chamber is stopped when temperature of the cooking chamber in the heat preservation and water absorption stage is greater than the fourth temperature.

The cooking chamber is heated when the temperature of the cooking chamber in the heat preservation and water absorption stage is less than the third temperature.

In an embodiment, the third temperature may be a difference between the second temperature and the controlled temperature, the fourth temperature is a sum of the second temperature and the controlled temperature, and an absolute value of the controlled temperature is less than or equal to 3° C.

In an embodiment, the beans may be white kidney beans, the second temperature is 60° C., the third temperature is 59° C., the fourth temperature is 61° C., the third preset duration is 30 minutes to 60 minutes, and the first preset duration is 10 minutes to 120 minutes.

In an embodiment, the pressure cooking stage may include a pressure increasing stage and a pressure keeping stage.

The operation of entering the pressure cooking stage when the duration of heat preservation and water absorption reaches the first preset duration, until cooking is finished, may include the following operations.

The pressure increasing stage is entered when the duration of heat preservation and water absorption reaches the first preset duration.

The pressure keeping stage is entered when the cooking chamber is pressurized to any one of third preset conditions in the pressure increasing stage.

The cooking is finished when a pressure keeping duration of the cooking chamber in the pressure keeping stage reaches a fourth preset duration.

The third preset conditions include that:
pressure of the cooking chamber is equal to or greater than a preset pressure; and
a pressurization duration of the cooking chamber in the pressure increasing stage is equal to or greater than a fifth preset duration.

According to a second aspect of the embodiments of the disclosure, there is provided a storage medium. The storage medium is readable by a computer and has stored thereon computer-executable instructions, the computer-executable instructions are configured to be executed by a processor to implement operations of any one of the above methods.

According to a third aspect of the embodiments of the disclosure, there is provided a cooking device. The cooking device includes a response module, a heat preservation module and a pressure cooking module.

The response module is configured to enter a temperature-rising and skin-breaking stage in response to a bean cooking start instruction.

The heat preservation module is configured to enter a heat preservation and water absorption stage after the temperature-rising and skin-breaking stage.

The pressure cooking module is configured to enter a pressure cooking stage when a duration of heat preservation and water absorption reaches a first preset duration, until cooking is finished.

According to a fourth aspect of the embodiments of the disclosure, there is provided a cooking appliance. The cooking appliance includes a memory and a processor, the memory stores computer-executable instructions, and the processor is configured to execute the computer-executable instructions to implement operations of any one of the above methods.

According to the method for cooking beans in the embodiments of the disclosure, skins of the beans are opened in the temperature-rising and skin-breaking stage, and the heat preservation and water absorption stage is entered after the temperature-rising and skin-breaking stage, so that the beans with skins opened may absorb water sufficiently in a relatively short time, which shortens a water absorption duration of the beans and thus shortens the whole cooking duration of the beans. When the duration of heat preservation and water absorption reaches the first preset duration, the beans with skins opened basically absorb water sufficiently, and the beans are cooked under pressure after entering the pressure cooking stage, until cooking is finished, so that the beans are better cooked thoroughly.

### BRIEF DESCRIPTION OF THE DRAWINGS

FIG. 1 is a flowchart of a method for cooking beans according to an embodiment of the disclosure, showing main operations of skin-breaking, water absorption, pressure cooking, etc.

FIG. 2 is a flowchart of a method for cooking beans according to an embodiment of the disclosure, showing operations of entering a cooling-down stage.

FIG. 3 is a flowchart of a method for cooking beans according to an embodiment of the disclosure, showing operations of entering a heat preservation and water absorption stage after cooling to certain conditions in the cooling-down stage.

FIG. 4 is a flowchart of a method for cooking beans according to an embodiment of the disclosure, showing a temperature control mode in the heat preservation and water absorption stage.

FIG. 5 is a flowchart of a method for cooking beans according to an embodiment of the disclosure, showing specific operations of a pressure cooking stage.

FIG. 6 is a flowchart of a method for cooking beans according to an embodiment of the disclosure, showing a pressure control mode in a pressure keeping stage.

FIG. 7 is a flowchart of a method for cooking beans according to an embodiment of the disclosure, showing a complete flow of a certain bean cooking.

FIG. 8 is a diagram showing a relationship of temperature of a cooking chamber changed with time in a process of cooking beans according to an embodiment of the disclosure, certain correspondences exist between pressure and temperature, and five intervals indicated by arrows from left to right along a time axis in the diagram represent a temperature-rising and skin-breaking stage, a cooling-down stage, a heat preservation and water absorption stage, a pressure increasing stage and a pressure keeping stage in sequence.

### DETAILED DESCRIPTION

It should be noted that the embodiments of the disclosure and technical features in the embodiments may be combined with each other without conflict, and detailed descriptions in specific implementations should be understood as explanation and description of the aim of the disclosure and should not be considered as improper limitations to the disclosure.

In the disclosure, cooking beans is described as an example for explanatory and illustrative purposes. The disclosure, however, is not limited thereto, but is applicable to any suitable foods.

In the related art, when beans are not sufficiently soaked to absorb water, it is difficult for a cooking appliance to cook the beans thoroughly, and hence the beans need to be soaked for a long time. Therefore, the whole cooking duration is long. It may be understood that when the beans are wrapped with skins, external water is blocked by the skins of the beans to a certain extent, and is difficult to permeate into the beans, the beans take a long duration to absorb water.

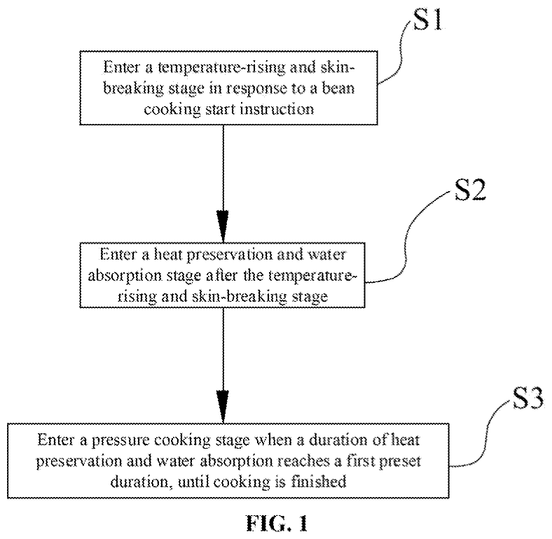

In view of this, an embodiment of the disclosure provides a method for cooking beans. The method can be applied to a cooking appliance, e.g., the cooking appliance can be controlled to perform the operations of any of the methods in the embodiments described below. With reference to FIG. 1, the method for cooking beans includes the following operation S1.

At S1, a temperature-rising and skin-breaking stage is entered in response to a bean cooking start instruction.

In this way, the beans are heated in the temperature-rising and skin-breaking stage, so that skins of the beans is opened, which reduces blockage of the skins of the beans to external water, is beneficial for external water to permeate into the beans, and allows the beans to absorb water sufficiently in a relatively short time.

In an embodiment, the beans may be kidney beans.

In an embodiment, the kidney beans may be white kidney beans.

It may be understood that the beans in the embodiments of the disclosure are not limited to white kidney beans, and beans which have properties similar to the white kidney beans and require absorbing water for cooking may be cooked by the method of the disclosure.

In an embodiment, the bean cooking start instruction may be that a bean cooking start button of a cooking appliance is pressed.

In an embodiment, the bean cooking start instruction may be sent to the cooking appliance through a terminal such as a mobile phone, etc.

In an embodiment, with reference to FIG. 1, the method for cooking beans further includes the following operations S2 and S3.

At S2, a heat preservation and water absorption stage is entered after the temperature-rising and skin-breaking stage.

At S3, a pressure cooking stage is entered when a duration of heat preservation and water absorption reaches a first preset duration, until cooking is finished.

In this way, the skins of the beans are opened in the temperature-rising and skin-breaking stage, and the heat preservation and water absorption stage is entered after the temperature-rising and skin-breaking stage, so that the beans with skins opened may absorb water sufficiently in a relatively short time, which shortens a water absorption duration of the beans and thus shortens the whole cooking duration of the beans. When the duration of heat preservation and water absorption reaches the first preset duration, the beans with skins opened basically absorb water sufficiently, and the beans are cooked under pressure after entering the pressure cooking stage, until cooking is finished, so that the beans are better cooked thoroughly.

In an embodiment, the first preset duration may be specifically determined according to experiments. Exemplarily, the first preset duration may be 10 minutes to 120 minutes.

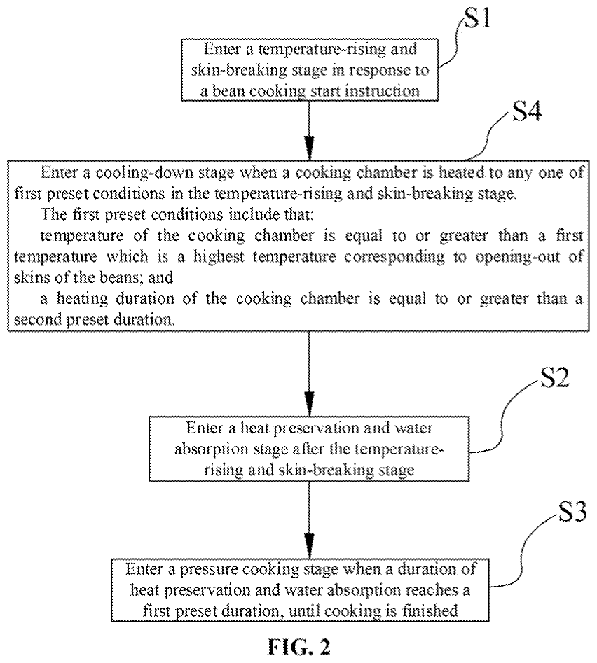

In an embodiment, with reference to FIG. 2, the method for cooking beans includes the following operation S4.

At S4, a cooling-down stage is entered when a cooking chamber is heated to any one of first preset conditions in the temperature-rising and skin-breaking stage.

The first preset conditions include that:
temperature of the cooking chamber is equal to or greater than a first temperature which is a highest temperature corresponding to opening of skins of the beans; and
a heating duration of the cooking chamber is equal to or greater than a second preset duration.

In this way, after the temperature-rising and skin-breaking stage, the beans with skins opened are prevented from being at a high temperature for a long time by cooling down the beans, which may reduce possibility of excessive breakage of the skins of the beans to a certain extent, and make the cooked beans more aesthetical and better mouth feel. Opening of the skin is related to temperature, and one of the first preset conditions is that the temperature of the cooking chamber is equal to or greater than the first temperature, that is, when temperature of the cooking chamber in the temperature-rising and skin-breaking stage is equal to or greater than the first temperature, the cooling-down stage is entered to prevent the beans with skins opened from being at a high temperature for a long time. It may be understood that abnormalities may occur to cooking of the beans when it is in the temperature-rising and skin-breaking stage for a long time and still does not enter the cooling-down stage, and it is not beneficial to cooking of the beans by continuing to be in the temperature-rising and skin-breaking stage. When the heating duration of the cooking chamber in the temperature-rising and skin-breaking stage is equal to or greater than the second preset duration, the cooling-down stage is entered, the heating duration of the cooking chamber in the temperature-rising and skin-breaking stage is compared to the second preset duration, to forcibly jump to the cooling-down stage by using time limitation, so that the whole cooking process continues to be executed, and there is still a possibility for the beans in the cooking chamber to be cooked thoroughly and eaten, which may reduce losses caused by cooking abnormalities as much as possible.

It may be understood that the second preset duration cannot be too short, a too short second preset duration may affect normal comparison between the temperature of the cooking chamber in the temperature-rising and skin-breaking stage and the first temperature, thus affecting normal jump in the temperature-rising and skin-breaking stage. The second preset duration is set according to actual requirements.

In an embodiment, the second preset duration is a duration required for the cooking chamber to be heated to the first temperature in a case that the cooking chamber is fully loaded. In this way, when the heating duration of the cooking chamber in the temperature-rising and skin-breaking stage is equal to or greater than the second preset duration, the temperature of the cooking chamber may basically reach the first temperature under normal conditions, to break the skins of the beans. In this case, when it still does not jump to the cooling-down stage through the temperature of the cooking chamber and the first temperature, it indicates that abnormalities may occur to cooking of the beans in the cooking chamber, and it is not suitable to continue to be in the temperature-rising and skin-breaking stage. It may jump to the cooling-down stage, so that the whole cooking process continues to be executed, and there is still a possibility for the beans in the cooking chamber to be cooked thoroughly and eaten, which may reduce losses caused by cooking abnormalities as much as possible.

It should be noted that a case where the cooking chamber is fully loaded, refers to a case where a water level in the cooking chamber is at a highest allowable water level.

It may understood that it requires the second preset duration to heat the cooking chamber to the first temperature, in a case that the water level in the cooking chamber is at the highest allowable water level. The cooking chamber cooks the beans, and the water level in the cooking chamber is less than or equal to the highest allowable water level. The duration required for the cooking chamber to be heated to the first temperature is less than the second preset duration under normal conditions.

In an embodiment, the beans are white kidney beans, and the first temperature is 95° C. to 105° C. In this way, the cooking chamber is heated to 95° C. to 105° C. in the temperature-rising and skin-breaking stage, so that skins of the white kidney beans may be opened better.

In an embodiment, the beans are white kidney beans, and the first temperature is 100° C. In this way, skins of the white kidney beans may be opened to a suitable degree.

It may be understood that the first temperature may be different for different kinds of beans. In an embodiment, the first temperature is 60° C. to 100° C.

In an embodiment, the first temperature corresponding to different kinds of beans may be obtained through experiments.

In an embodiment, the second preset duration is 30 minutes to 60 minutes.

In an embodiment, the second preset duration may be obtained through experiments.

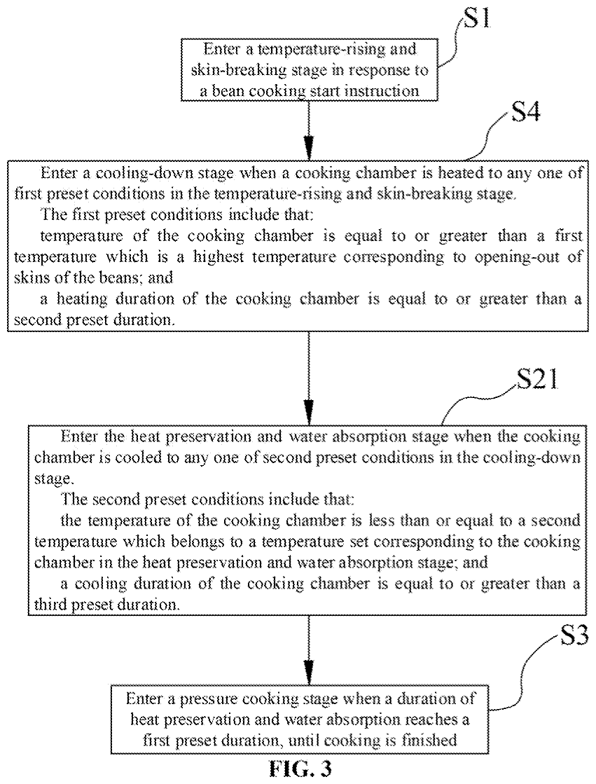

In an embodiment, with reference to FIG. 3, the operation of entering the heat preservation and water absorption stage after the temperature-rising and skin-breaking stage includes the following operation S21.

At S21, the heat preservation and water absorption stage is entered when the cooking chamber is cooled to any one of second preset conditions in the cooling-down stage.

The second preset conditions include that:
the temperature of the cooking chamber is less than or equal to a second temperature which belongs to a temperature set corresponding to the cooking chamber in the heat preservation and water absorption stage; and
a cooling duration of the cooking chamber is equal to or greater than a third preset duration.

In this way, the heat preservation and water absorption stage is entered by cooling down, in the cooling-down stage, to the second temperature which belongs to the temperature set corresponding to the cooking chamber in the heat preservation and water absorption stage, which may better ensure that the beans in the cooking chamber absorb water for a long enough duration in the corresponding temperature set, so that the beans absorb water sufficiently, therefore it is beneficial to better cook the beans thoroughly. It may be understood that too cold temperature of the cooking chamber is not beneficial for water absorption, therefore the cooling duration of the cooking chamber should not be too long. When the cooling duration of the cooking chamber is too long, it still does not jump to the heat preservation and water absorption stage, which indicates that abnormalities may occur to cooking of the beans in the cooling-down stage, and it is not suitable to continue to be in the cooling-down stage. When the cooling duration of the cooking chamber in the cooling-down stage is equal to or greater than the third preset duration, the heat preservation and water absorption stage is entered. The cooling duration of the cooking chamber is compared to the third preset duration, to forcibly jump to the heat preservation and water absorption stage, so that the whole cooking process continues to be executed, and there is still a possibility for the beans in the cooking chamber to be cooked thoroughly and eaten, which may reduce losses caused by cooking abnormalities as much as possible.

In an embodiment, the third preset duration is a duration required for the cooking chamber to drop from the first temperature to the second temperature in a case that the cooking chamber is fully loaded. In this way, when the cooling duration of the cooking chamber is equal to or greater than the third preset duration, the temperature of the cooking chamber is basically cooled to the second temperature under normal conditions. When it still does not jump to the heat preservation and water absorption stage through comparison of the temperature of the cooking chamber to the second temperature, it indicates that abnormalities may occur to cooking of the beans in the cooking chamber, and it is not suitable to continue to be in the cooling-down stage to cool the cooking chamber. The cooling duration of the cooking chamber in the cooling-down stage is compared to the third preset duration, to forcibly jump to the heat preservation and water absorption stage by using time limitation, so that the whole cooking process continues to be executed, and there is still a possibility for the beans in the cooking chamber to be cooked thoroughly and eaten, which may reduce losses caused by cooking abnormalities as much as possible.

It should be noted that a case where the cooking chamber is fully loaded, refers to a case where a water level in the cooking chamber is at a highest allowable water level.

It may understood that the duration required for the temperature of the cooking chamber to drop from the first temperature to the second temperature is the third preset duration, in a case that the water level in the cooking chamber is at the highest allowable water level. The beans in the cooking chamber are cooked, and the water level in the cooking chamber is less than or equal to the highest allowable water level. The duration for the temperature of the cooking chamber to be cooled from the first temperature to the second temperature is less than the third preset duration.

In an embodiment, the third preset duration may be obtained through experiments.

In an embodiment, the second temperature is a temperature at which the cooking chamber is suitable for the beans to absorb water in the heat preservation and water absorption stage.

In an embodiment, the second temperature may be 50° C. to 100° C. according to different kinds of beans.

It may be understood that the second temperature corresponding to different kinds of beans may be different. In an embodiment, the beans are white kidney beans, and the second temperature corresponding to the white kidney beans is 60° C.

In an embodiment, the beans are white kidney beans, and the third preset duration is 30 minutes to 60 minutes.

It may be understood that the beans have a preferred water absorption temperature which may be obtained through experiments.

In an embodiment, the beans are white kidney beans. When the temperature of the cooking chamber in the heat preservation and water absorption stage is 60° C., the white kidney beans have a suitable water absorption rate, which may prevent excessive breakage of skins of the white kidney beans as much as possible.

Exemplarily, an example of adding 200 g of white kidney beans to 1500 g of water and making the white kidney beans keep temperature and absorb water for 60 minutes in the heat preservation and water absorption stage is taken for descriptions. When the temperature of the cooking chamber in the heat preservation and water absorption stage is 90° C.+/−3° C., the white kidney beans may be basically cooked thoroughly, while the skins of the white kidney beans are broken seriously. When the temperature of the cooking chamber in the heat preservation and water absorption stage is 80° C.+/−3° C., the white kidney beans may be basically cooked thoroughly; although broken degree of the skins of the white kidney beans is lighter than broken degree in a case that the temperature of the cooking chamber in the heat preservation and water absorption stage is 90° C.+/−3° C., serious breakage of the skins of the white kidney beans still exists. When the temperature of the cooking chamber in the heat preservation and water absorption stage is 70° C.+/−3° C., the white kidney beans may be basically cooked thoroughly; although broken degree of the skins of the white kidney beans is lighter than the broken degree in a case that the temperature of the cooking chamber in the heat preservation and water absorption stage is 80° C.+/−3° C., serious breakage of the skins of the white kidney beans still exists. When the temperature of the cooking chamber in the heat preservation and water absorption stage is 60° C.+/−3° C., the white kidney beans may be basically cooked thoroughly; although the skins of the white kidney beans are opened to a certain extent, to break the skins of the white kidney beans to make the white kidney beans absorb water, the skins of the white kidney beans are relatively complete, and the cooked white kidney beans have a good appearance and mouth feel. When the temperature of the cooking chamber in the heat preservation and water absorption stage is 50° C.+/−3° C., the skins of the white kidney beans are relatively complete, while the cooked beans have a small amount of white cores and are not fully cooked thoroughly. When the temperature of the cooking chamber in the heat preservation and water absorption stage is 40° C.+/−3° C., the skins of the white kidney beans are relatively complete, while the cooked beans have a small amount of white cores and are not fully cooked thoroughly. When the temperature of the cooking chamber in the heat preservation and water absorption stage is 30° C.+/−3° C., the skins of the white kidney beans are relatively complete, while the cooked beans have a small amount of white cores and are not fully cooked thoroughly.

It may be known from the above experiments that the preferred water absorption temperature of the white kidney bean is about 60° C.

In an ideal state, the beans may be kept at the preferred water absorption temperature to absorb water at a constant temperature. However, in an actual situation, the temperature of the cooking chamber may inevitably fluctuate to a certain extent in the heat preservation and water absorption stage, and the cooking chamber needs to be properly heated or cooled in the heat preservation and water absorption stage; preferred water absorption temperature of a part of the beans is not too high, and correspondingly, the temperature of the cooking chamber in the heat preservation and water absorption stage is not too high, power of a heating device for heating the cooking chamber is not too large. When the heating device stops heating to cool the cooking chamber, waste heat of the heating device is small, and a cooling-down speed of the cooking chamber is relatively fast.

Exemplarily, the cooking chamber is heated by the heating device which is provided with an ON state for heating the cooking chamber and an OFF state for cooling down the cooking chamber. When the heating device is in the ON state for heating the cooking chamber, the heating device performs heating only in a part of a heating cycle of the heating device. When the heating device is in the ON state for heating the cooking chamber, the higher the power ratio of the heating device, the longer the heating duration of the heating device in the heating cycle, and the lower the power ratio of the heating device, the shorter the heating duration of the heating device in the heating cycle. In the heat preservation and water absorption stage, power of the heating device for heating the cooking chamber is not too large, and correspondingly, the power ratio of the heating device is small, heat of the heating device may be quickly dissipated without accumulating a large amount of waste heat.

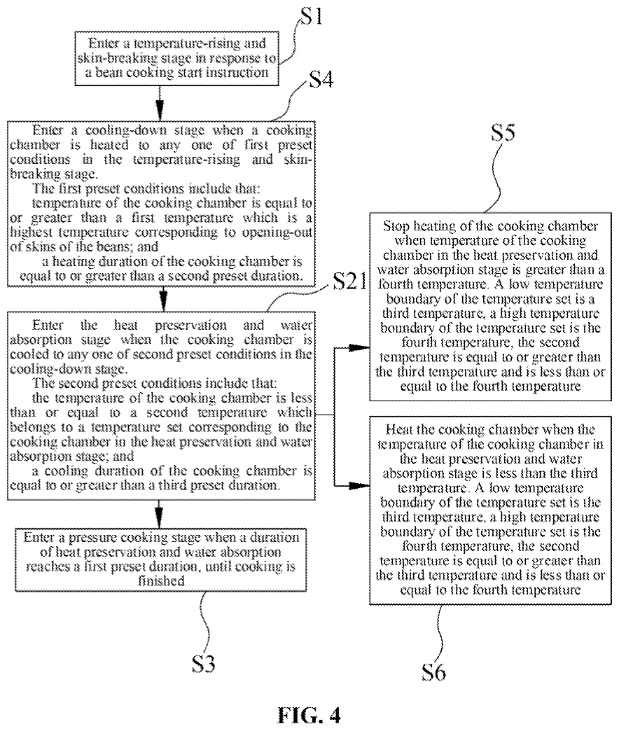

In an embodiment, with reference to FIG. 4, a low temperature boundary of the temperature set is a third temperature, a high temperature boundary of the temperature set is a fourth temperature, the second temperature is equal to or greater than the third temperature and is less than or equal to the fourth temperature. The method for cooking beans further includes the following operations S5 and S6.

At S5, heating of the cooking chamber is stopped when temperature of the cooking chamber in the heat preservation and water absorption stage is greater than the fourth temperature.

At S6, the cooking chamber is heated when the temperature of the cooking chamber in the heat preservation and water absorption stage is less than the third temperature.

In this way, when the cooking chamber is in the heat preservation and water absorption stage, the temperature of the cooking chamber may be changed between the third temperature and the fourth temperature. It needs some time to heat the temperature of the cooking chamber from the third temperature to the fourth temperature, or it needs some time to cool the temperature of the cooking chamber from the fourth temperature to the third temperature, so that switching frequencies of the heating device between the ON state for heating the cooking chamber and the OFF state for cooling the cooking chamber may be reduced to a certain extent, and correspondingly, operating frequencies of a switching device in a control circuit of the heating device may be reduced, thereby prolonging service life of the switching device.

It should be noted that the temperature set includes the low temperature boundary and the high temperature boundary, that is, the temperature set includes the third temperature and the fourth temperature.

It should be noted that the low temperature boundary and the high temperature boundary are named relatively, and temperature of the low temperature boundary is less than that of the high temperature boundary. Exemplarily, the low temperature boundary is the third temperature, the high temperature boundary is the fourth temperature, and the third temperature is less than the fourth temperature.

In an embodiment, the third temperature is a difference between the second temperature and a controlled temperature, the fourth temperature is a sum of the second temperature and the controlled temperature. In this way, the cooking chamber may enter the heat preservation and water absorption stage at a suitable temperature, and the temperature of the cooking chamber in the heat preservation and water absorption stage fluctuates up and down at a suitable second temperature, which is beneficial for the beans to absorb water better.

In an embodiment, an absolute value of the controlled temperature is less than or equal to 3° C. Exemplarily, the second temperature is T₂, and a temperature range of the cooking chamber in the heat preservation and water absorption stage is T₂+/−3° C.

In an embodiment, the beans are white kidney beans, the second temperature is 60° C., the third temperature is 59° C., and the fourth temperature is 61° C.

It may be understood that the temperature set corresponding to the cooking chamber in the heat preservation and water absorption stage is not limited to a temperature range between the third temperature and the fourth temperature, inclusive.

In an embodiment, the temperature set corresponding to the cooking chamber in the heat preservation and water absorption stage may be a specific temperature value.

Exemplarily, the temperatures set corresponding to the cooking chamber in the heat preservation and water absorption stage is the second temperature, heating of the cooking chamber is stopped when the temperature of the cooking chamber is equal to or greater than the second temperature in the heat preservation and water absorption stage, and the cooking chamber is heated when the temperature of the cooking chamber is less than the second temperature in the heat preservation and water absorption stage.

Exemplarily, the beans are white kidney beans, and the temperature set corresponding to the cooking chamber in the heat preservation and water absorption stage is 60° C.

In an embodiment, preferred water absorption temperature of a part of the beans may coincide with the first temperature, and the heat preservation and water absorption stage is entered when the cooking chamber is heated to any one of the first preset conditions in the temperature-rising and skin-breaking stage. In this case, the cooling-down stage will not exist, and the cooking chamber directly enters the heat preservation and water absorption stage after the temperature-rising and skin-breaking stage.

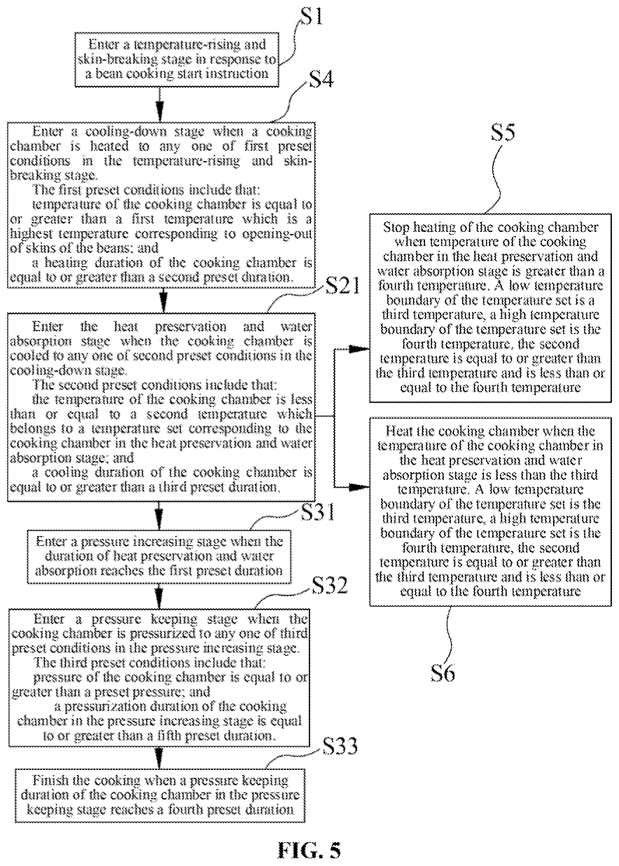

In an embodiment, with reference to FIG. 5, the pressure cooking stage includes a pressure increasing stage and a pressure keeping stage. The operation of entering the pressure cooking stage when the duration of heat preservation and water absorption reaches the first preset duration, until cooking is finished, includes the following operations S31 to S33.

At S31, the pressure increasing stage is entered when the duration of heat preservation and water absorption reaches the first preset duration.

At S32, the pressure keeping stage is entered when the cooking chamber is pressurized to any one of third preset conditions in the pressure increasing stage.

At S33, the cooking is finished when a pressure keeping duration of the cooking chamber in the pressure keeping stage reaches a fourth preset duration.

The third preset conditions include that:
pressure of the cooking chamber is equal to or greater than a preset pressure; and
a pressurization duration of the cooking chamber in the pressure increasing stage is equal to or greater than a fifth preset duration.

In this way, the beans in the cooking chamber absorb water sufficiently in the heat preservation and water absorption stage. After the heat preservation and water absorption stage, the pressure increasing stage is entered to increase the pressure of the cooking chamber to cook the beans in the cooking chamber under pressure. After the cooking chamber is pressurized to a certain extent, the pressure keeping stage is entered so that the beans in the cooking chamber are cooked in a certain pressure range, which is beneficial to quickly cooking the beans after absorbing water thoroughly and may shorten the cooking duration of the beans to a certain extent. When the pressure of the cooking chamber is equal to or greater than the preset pressure, the pressure keeping stage is entered, that is, after the cooking chamber reaches the preset pressure, the pressure keeping stage is entered to start timing of the pressure keeping duration, which may ensure that the beans in the cooking chamber may be cooked near the preset pressure for a long enough duration, so that the beans in the cooking chamber are cooked thoroughly. The cooking chamber cannot be always in the pressure increasing stage, which may make the pressure in the cooking chamber exceed a pressure-bearing capacity of the cooking device, resulting in potential safety hazards. The pressurization duration of the cooking chamber in the pressure increasing stage is compared to the fifth preset duration, and the pressure keeping stage is entered when the pressurization duration of the cooking chamber in the pressure increasing stage is equal to or greater than the fifth preset duration, the cooking chamber enters maintaining stage, to forcibly jump to the pressure keeping stage by using time limitation, which may prevent potential safety hazards caused by excessive pressure in the cooking chamber to a certain extent.

It may be understood that according to different kinds of beans, the fourth preset duration is also different. Exemplarily, the fourth preset duration is 5 minutes to 4 hours.

In an embodiment, the beans are white kidney beans, and the fourth preset duration may be 15 minutes.

In an embodiment, the fifth preset duration is a duration for a lowest pressure corresponding to the heat preservation and water absorption stage to be pressurized to the preset pressure.

In an embodiment, the fifth preset duration may be obtained according to experiments.

In an embodiment, the preset pressure may be 20 kpa to 80 kpa.

In an embodiment, the beans are white kidney beans, and the preset pressure may be 40 kpa.

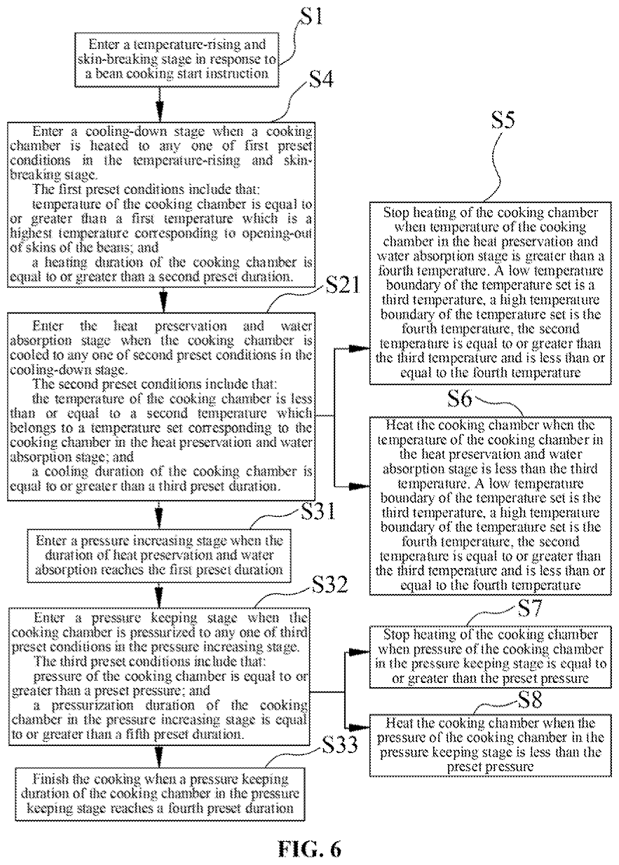

In an embodiment, with reference to FIG. 6, the cooking chamber is heated by a hot plate, the method for cooking beans further includes the following operations S7 and S8.

At S7, heating of the cooking chamber is stopped when pressure of the cooking chamber in the pressure keeping stage is equal to or greater than the preset pressure.

At S8, the cooking chamber is heated when the pressure of the cooking chamber in the pressure keeping stage is less than the preset pressure.

In this way, the hot plate has a large thermal inertia, thus when the cooking chamber is equal to or greater than the preset pressure in the pressure keeping stage, both pressure and temperature of the cooking chamber are high, power of the hot plate heating the cooking chamber is large, and the power ratio is large. When the hot plate stops heating the cooking chamber, the hot plate still has large waste heat. After the hot plate stops heating, the pressure of the cooking chamber may continue to increase for a period of time and then drop to be less than the preset pressure under influence of the waste heat of the hot plate, and the hot plate heats the cooking chamber. On one hand, due to the thermal inertia of the hot plate, switching frequencies of the heating device between the ON state and the OFF state may be reduced, and correspondingly, the switching device in the control circuit of the heating device may not operate too frequently. On the other hand, a pressure keeping control method is simple, and pressure control in the pressure keeping stage may be achieved by one pressure parameter, i.e., the preset pressure.

An example of the whole cooking process of beans is described below.

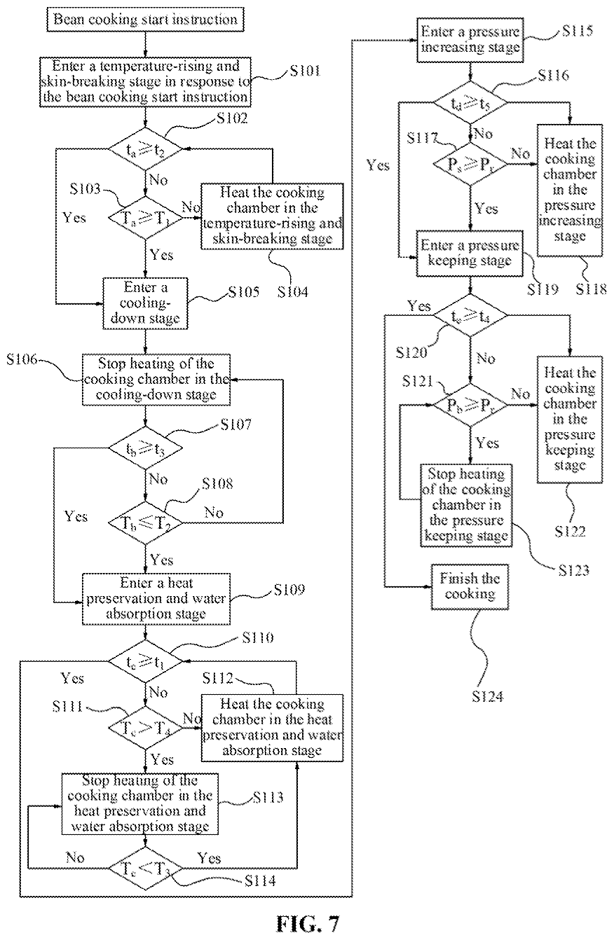

In an embodiment, with reference to FIG. 7, the method for cooking beans includes the following operations.

At S101, a temperature-rising and skin-breaking stage is entered in response to a bean cooking start instruction.

Skins of the beans in the cooking chamber are opened through the temperature-rising and skin-breaking stage.

At S102, it is determined whether a heating duration of the cooking chamber in the temperature-rising and skin-breaking stage is equal to or greater than the second preset duration. If yes, operation S105 is executed. If no, operation S103 is executed.

The heating duration of the cooking chamber in the temperature-rising and skin-breaking stage is tₐ, and the second preset duration is t₂. The operation of determining whether the heating duration of the cooking chamber in the temperature-rising and skin-breaking stage is equal to or greater than the second preset duration, refers to determining tₐ≥t₂.

At S103, it is determined whether temperature of the cooking chamber in the temperature-rising and skin-breaking stage is equal to or greater than the first temperature. If yes, operation S105 is executed. If no, operation S104 is executed.

The temperature of the cooking chamber in the temperature-rising and skin-breaking stage is Tₐ, and the first temperature is T₁. The operation of determining whether the temperature of the cooking chamber in the temperature-rising and skin-breaking stage is equal to or greater than the first temperature, refers to determining Tₐ≥T₁.

At S104, the cooking chamber is heated in the temperature-rising and skin-breaking stage, and operation S102 is executed.

At S105, a cooling-down stage is entered.

Excessive breakage of the skins of beans is prevented by cooling down.

At S106, heating of the cooking chamber is stopped in the cooling-down stage.

At S107, it is determined whether a cooling duration of the cooking chamber in the cooling-down stage is equal to or greater than the third preset duration. If yes, operation S109 is executed. If no, operation S108 is executed.

The cooling duration of the cooking chamber in the cooling-down stage is t_{b}, and the third preset duration is t₃. The operation of determining whether the cooling duration of the cooking chamber in the cooling-down stage is equal to or greater than the third preset duration, refers to determining t_{b}≥t₃.

At S108, it is determined whether temperature of the cooking chamber in the cooling-down stage is less than or equal to the second temperature. If yes, operation S109 is executed. If no, operation S106 is executed.

The temperature of the cooking chamber in the cooling-down stage is T_{b}, and the second temperature is T₂. The operation of determining whether the temperature of the cooking chamber in the cooling-down stage is less than or equal to the second temperature, refers to determining T_{b}≤T₂.

At S109, a heat preservation and water absorption stage is entered.

At S110, it is determined whether a duration of heat preservation and water absorption reaches the first preset duration. If yes, operation S115 is executed. If no, operation S111 is executed.

The duration of heat preservation and water absorption of the beans is t_{c}, and the first preset duration is t₁. The operation of determining whether the duration of heat preservation and water absorption reaches the first preset duration, refers to determining t_{c}≥t₁.

At S111, it is determined whether temperature of the cooking chamber in the heat preservation and water absorption stage is greater than the fourth temperature. If yes, operation S113 is executed. If no, operation S112 is executed.

The temperature of the cooking chamber in the heat preservation and water absorption stage is T_{C}, and the fourth temperature is T₄. The operation of determining whether the temperature of the cooking chamber in the heat preservation and water absorption stage is greater than the fourth temperature, refers to determining T_{C}>T₄.

At S112, the cooking chamber is heated in the heat preservation and water absorption stage, and operation S110 is executed.

At S113, heating of the cooking chamber is stopped in the heat preservation and water absorption stage.

At S114, it is determined whether the temperature of the cooking chamber in the heat preservation and water absorption stage is less than the third temperature. If yes, operation S112 is executed. If no, operation S113 is executed.

The temperature of the cooking chamber in the heat preservation and water absorption stage is T_{C}, and the third temperature is T₃. The operation of determining whether the temperature of the cooking chamber in the heat preservation and water absorption stage is less than the third temperature, refers to determining T_{C}<T₃.

The beans absorb water sufficiently in the heat preservation and water absorption stage.

At S115, a pressure increasing stage is entered.

At S116, it is determined whether a pressurization duration of the cooking chamber in the pressure increasing stage is equal to or greater than the fifth preset duration. If yes, operation S119 is executed. If no, operation S117 is executed.

The pressurization duration of the cooking chamber in the pressure increasing stage is t_{d}, and the fifth preset duration is t₅. The operation of determining whether the pressurization duration of the cooking chamber in the pressure increasing stage is equal to or greater than the fifth preset duration, refers to determining t_{d}≥t₅.

At S117, it is determined whether a pressure of the cooking chamber in the pressure increasing stage is equal to or greater than the preset pressure. If yes, operation S119 is executed. If no, operation S118 is executed.

The pressure of the cooking chamber in the pressure increasing stage is Pₛ, and the preset pressure is Pᵣ. The operation of determining whether the pressure of the cooking chamber in the pressure increasing stage is equal to or greater than the preset pressure, refers to determining Pₛ≥Pᵣ.

At S118, the cooking chamber is heated in the pressure increasing stage, and operation S116 is executed.

At S119, a pressure keeping stage is entered.

At S120, it is determined whether a pressure keeping duration of the cooking chamber in the pressure keeping stage reaches the fourth preset duration. If yes, operation S124 is executed. If no, operation S121 is executed.

The pressure keeping duration of the cooking chamber in the pressure keeping stage is tₑ, and the fourth preset duration is t₄. The operation of determining whether the pressure keeping duration of the cooking chamber in the pressure keeping stage reaches the fourth preset duration, refers to determining tₑ≥t₄.

At S121, it is determined whether a pressure of the cooking chamber in the pressure keeping stage is equal to or greater than the preset pressure. If yes, operation S123 is executed. If no, operation S122 is executed.

The pressure of the cooking chamber in the pressure keeping stage is P_{b}, and the preset pressure is Pᵣ. The operation of determining whether the pressure of the cooking chamber in the pressure keeping stage is equal to or greater than the preset pressure, refers to determining P_{b}≥Pᵣ.

At S122, the cooking chamber is heated in the pressure keeping stage, and operation S120 is executed.

At S123, heating of the cooking chamber is stopped in the pressure keeping stage, and operation S121 is executed.

At S124, the cooking is finished.

The beans after absorbing water are cooked under a certain pressure, so that the beans are quickly cooked thoroughly.

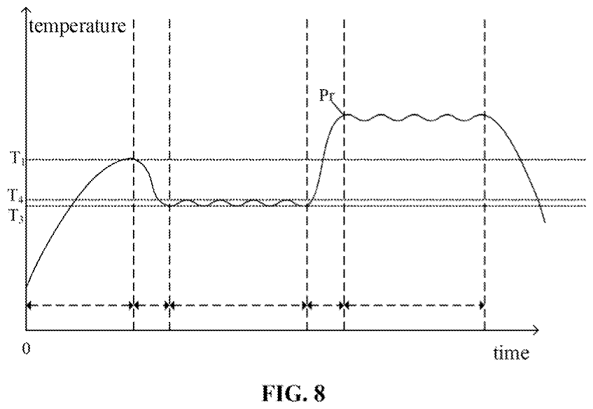

In an embodiment, with reference to FIG. 8 in which the abscissa is time and the ordinate is temperature, a relationship of temperature of the cooking chamber changed with time in the cooking process is shown schematically, and each stage of the bean cooking process is shown schematically.

An embodiment of the disclosure provides a storage medium. The storage medium is readable by a computer and has stored thereon computer-executable instructions, the computer-executable instructions may be executed by a processor to implement operations of the method for cooking beans in any one of the above embodiments.

In an embodiment, the computer-readable storage medium may be a memory such as a Ferroelectric Random Access Memory (FRAM), a Read-Only Memory (ROM), a Programmable Read-Only Memory (PROM), an Electrically Programmable Read-Only Memory (EPROM), an Electrically Erasable Programmable Read-Only Memory (EEPROM), a flash memory, a magnetic surface memory, an optical disk, or a Compact Disk Read-Only Memory (CD-ROM) or the like; and may also be various devices including one or any combination of the above memories.

In an embodiment, the executable instructions may be in a form of programs, software, software modules, scripts or codes, may be written in any form of programming languages (including compiling or interpreting languages, or declarative or procedural languages), and may be deployed in any form, including that they are deployed as stand-alone programs or modules, components, subroutines, or other units suitable to be used in a computer environment.

Exemplarily, the executable instructions may but do not necessarily correspond to a file in a file system, may be stored in a part of a file storing other programs or data, for example, stored in one or more scripts in a Hyper Text Markup Language (HTML) document, stored in a single file dedicated to the discussed program, or stored in multiple collaborative files.

Exemplarily, the executable instructions may be deployed to be executed on a computing device, or executed on multiple computing devices located at a location, or executed on multiple computing devices distributed at multiple locations and interconnected through a network.

An embodiment of the disclosure provides a cooking device. The cooking device includes a response module, a heat preservation module and a pressure cooking module. The response module is configured to enter a temperature-rising and skin-breaking stage in response to a bean cooking start instruction. The heat preservation module is configured to enter a heat preservation and water absorption stage after the temperature-rising and skin-breaking stage. The pressure cooking module is configured to enter a pressure cooking stage when a duration of heat preservation and water absorption reaches a first preset duration, until cooking is finished.

The response module responds to the bean cooking start instruction and enters the temperature-rising and skin-breaking stage. The beans are heated in the temperature-rising and skin-breaking stage, so that skins are opened to facilitate absorbing water. The heat preservation module enters the heat preservation and water absorption stage, so that the beans quickly absorb water sufficiently in the heat preservation and water absorption stage. The beans after absorbing water are cooked under a certain pressure in the pressure cooking stage, so that the beans are quickly cooked thoroughly.

An embodiment of the disclosure provides a cooking appliance. The cooking appliance includes a memory and a processor, the memory stores computer-executable instructions, and the processor is configured to execute the computer-executable instructions to implement operations of the method for cooking beans in any one of the above embodiments.

In an embodiment, the cooking appliance is a pressure cooker.

In an embodiment, the cooking appliance is an electric pressure cooker.

The above descriptions are only some embodiments of the disclosure and are not intended to limit the disclosure. The disclosure may be subjected to various changes and variations by those skilled in the art. Any modification, equivalent replacement, improvement, or the like made within the spirit and principle of the disclosure should be included in the scope of protection of the disclosure.

1. A method for cooking comprising:
controlling a cooking appliance to enter a temperature-rising and skin-breaking stage in response to a cooking start instruction;
controlling the cooking appliance to enter a heat preservation and water absorption stage after the temperature-rising and skin-breaking stage; and
controlling the cooking appliance to enter a pressure cooking stage in response to a duration of heat preservation and water absorption reaches a preset duration, until cooking is finished.

2. The method of claim 1, further comprising:
controlling the cooking appliance to enter a cooling-down stage in response to a preset condition being met in the temperature-rising and skin-breaking stage;
wherein:
the preset duration is a first preset duration; and
the preset condition includes:
temperature of a cooking chamber of the cooking appliance being equal to or greater than a first temperature which is a highest temperature corresponding to opening of skins of food being cooked; or
a heating duration of the cooking chamber being equal to or greater than a second preset duration.

3. The method of claim 2, wherein the second preset duration is a duration required for the cooking chamber to be heated to the first temperature in a case that the cooking chamber is fully loaded.

4. The method of claim 2, wherein the food being cooked includes white kidney beans, the first temperature is 95° C. to 105° C., and the second preset duration is 30 minutes to 60 minutes.

5. The method of claim 2, wherein:
the preset condition is a first preset condition;
controlling the cooking appliance to enter the heat preservation and water absorption stage after the temperature-rising and skin-breaking stage includes controlling the cooking appliance to enter the heat preservation and water absorption stage in response to a second preset condition being met in the cooling-down stage; and
the second preset condition includes:
the temperature of the cooking chamber being less than or equal to a second temperature which belongs to a temperature set corresponding to the cooking chamber in the heat preservation and water absorption stage; or
a cooling duration of the cooking chamber being equal to or greater than a third preset duration.

6. The method of claim 5, wherein the third preset duration is a duration required for the cooking chamber to drop from the first temperature to the second temperature in a case that the cooking chamber is fully loaded.

7. The method of claim 5,
wherein a low temperature boundary of the temperature set is a third temperature, a high temperature boundary of the temperature set is a fourth temperature, the second temperature is equal to or greater than the third temperature and is less than or equal to the fourth temperature;
the method further comprising:
stopping heating of the cooking chamber in response to the temperature of the cooking chamber in the heat preservation and water absorption stage being greater than the fourth temperature; and
heating the cooking chamber in response to the temperature of the cooking chamber in the heat preservation and water absorption stage being less than the third temperature.

8. The method of claim 7, wherein the third temperature is a difference between the second temperature and a controlled temperature, the fourth temperature is a sum of the second temperature and the controlled temperature, and an absolute value of the controlled temperature is less than or equal to 3° C.

9. The method of claim 8, wherein the food being cooked includes white kidney beans, the second temperature is 60° C., the third temperature is 59° C., the fourth temperature is 61° C., the third preset duration is 30 minutes to 60 minutes, and the first preset duration is 10 minutes to 120 minutes.

10. The method of claim 1, wherein:
the pressure cooking stage includes a pressure increasing stage and a pressure keeping stage;
the preset duration is a first preset duration;
controlling the cooking appliance to enter the pressure cooking stage in response to the duration of the heat preservation and water absorption reaches the first preset duration, until cooking is finished includes:
controlling the cooking appliance to enter the pressure increasing stage in response to the duration of the heat preservation and water absorption reaches the first preset duration;
controlling the cooking appliance to enter the pressure keeping stage in response to a preset condition being met in the pressure increasing stage; and
finishing the cooking in response to a pressure keeping duration of a cooking chamber of the cooking appliance in the pressure keeping stage reaching a second preset duration; and
the preset condition includes:
pressure of the cooking chamber being equal to or greater than a preset pressure; or
a pressurization duration of the cooking chamber in the pressure increasing stage equal to or greater than a third preset duration.

11. A non-transitory computer-readable storage medium storing computer-executable instructions that, when executed by a processor, cause the processor to:
control a cooking appliance to enter a temperature-rising and skin-breaking stage in response to a cooking start instruction;
control the cooking appliance to enter a heat preservation and water absorption stage after the temperature-rising and skin-breaking stage; and
control the cooking appliance to enter a pressure cooking stage in response to a duration of heat preservation and water absorption reaches a preset duration, until cooking is finished.

12. A cooking appliance comprising:
a memory storing computer-executable instructions; and
a processor configured to execute the computer-executable instructions to:
control the cooking appliance to enter a temperature-rising and skin-breaking stage in response to a cooking start instruction;
control the cooking appliance to enter a heat preservation and water absorption stage after the temperature-rising and skin-breaking stage; and
control the cooking appliance to enter a pressure cooking stage in response to a duration of heat preservation and water absorption reaches a preset duration, until cooking is finished.

13. The cooking appliance of claim 12, wherein:
the preset duration is a first preset duration;
the processor is further configured to execute the computer-executable instructions to:
control the cooking appliance to enter a cooling-down stage in response to a preset condition being met in the temperature-rising and skin-breaking stage; and
the preset condition includes:
temperature of a cooking chamber of the cooking appliance being equal to or greater than a first temperature which is a highest temperature corresponding to opening of skins of food being cooked; or
a heating duration of the cooking chamber being equal to or greater than a second preset duration.

14. The cooking appliance of claim 13, wherein the second preset duration is a duration required for the cooking chamber to be heated to the first temperature in a case that the cooking chamber is fully loaded.

15. The cooking appliance of claim 13, wherein the food being cooked includes white kidney beans, the first temperature is 95° C. to 105° C., and the second preset duration is 30 minutes to 60 minutes.

16. The cooking appliance of claim 13, wherein:
the preset condition is a first preset condition;
the processor is further configured to execute the computer-executable instructions to control the cooking appliance to enter the heat preservation and water absorption stage in response to a second preset condition being met in the cooling-down stage; and
the second preset condition includes:
the temperature of the cooking chamber being less than or equal to a second temperature which belongs to a temperature set corresponding to the cooking chamber in the heat preservation and water absorption stage; or
a cooling duration of the cooking chamber being equal to or greater than a third preset duration.

17. The cooking appliance of claim 16, wherein the third preset duration is a duration required for the cooking chamber to drop from the first temperature to the second temperature in a case that the cooking chamber is fully loaded.

18. The cooking appliance of claim 16, wherein:
a low temperature boundary of the temperature set is a third temperature, a high temperature boundary of the temperature set is a fourth temperature, the second temperature is equal to or greater than the third temperature and is less than or equal to the fourth temperature; and
the processor is further configured to execute the computer-executable instructions to:
stop heating of the cooking chamber in response to the temperature of the cooking chamber in the heat preservation and water absorption stage being greater than the fourth temperature; and
heat the cooking chamber in response to the temperature of the cooking chamber in the heat preservation and water absorption stage being less than the third temperature.

19. The cooking appliance of claim 18, wherein the third temperature is a difference between the second temperature and a controlled temperature, the fourth temperature is a sum of the second temperature and the controlled temperature, and an absolute value of the controlled temperature is less than or equal to 3° C.

20. The cooking appliance of claim 19, wherein the food being cooked includes white kidney beans, the second temperature is 60° C., the third temperature is 59° C., the fourth temperature is 61° C., the third preset duration is 30 minutes to 60 minutes, and the first preset duration is 10 minutes to 120 minutes.
